(19) United States
(12) Patent Application Publication
(10) Pub. No.: US 2020/0297142 A1
(43) Pub. Date: Sep. 24, 2020

(54) PRESSURE FRYER

(71) Applicant: The Broaster Company, Beloit, WI (US)

(72) Inventors: Otley D. Freymiller, Deerfield, WI (US); Sean Spors, Rockton, IL (US)

(21) Appl. No.: 16/895,413

(22) Filed: Jun. 8, 2020

Related U.S. Application Data
(63) Continuation-in-part of application No. 16/702,171, filed on Dec. 3, 2019.
(60) Provisional application No. 62/774,616, filed on Dec. 3, 2018.

(51) Int. Cl. A47J 27/08; A47J 27/084; A47J 27/086; A47J 36/06; A47J 36/36

(52) U.S. Cl. CPC A47J 27/0817; A47J 27/084; A47J 36/36; A47J 27/0802; A47J 36/06; A47J 27/086

(57) ABSTRACT

A pressure fryer includes a cooking well having a conical bottom and a substantially vertical sidewall extending upwardly from the conical bottom. A series of vertical fins is mounted to the sidewall. The vertical fins are spaced from one another and a series of undulating fins are mounted between the vertical fins. A heat shield surrounds the cooking well and vertical and undulating fins. The heat shield has an upper wall extending to the cooking well and an outer cover that covers the heat shield and defines an exhaust gas chamber between the outer cover and the heat shield. The fryer includes a multi-shelf rack system and a lift operably connected to the multi-shelf rack system.

### CROSS-REFERENCE TO RELATED APPLICATION DATA

This application is a continuation-in-part of U.S. patent application Ser. No. 16/702,171, filed Dec. 3, 2019, titled PRESSURE FRYER, which claims the benefit of and priority to Provisional U.S. patent application Ser. No. 62/774,616, filed Dec. 3, 2018, titled PRESSURE FRYER, the disclosures of which are incorporated herein in their entireties.

### BACKGROUND

The present disclosure relates to a pressure fryer, and more particularly to a high efficiency cooking system and filtering system for a pressure fryer.

Pressure fryers use a sealed, pressurized environment in which foods are cooked. Such a cooking technique locks in the flavor of, and moisture in, the food and reduces the amount of oil that is absorbed by the food. The decrease in oil absorption extends the oil's useful life and thus reduces costs compared to deep frying. In addition, the reduced absorption of oil in the food reduces the transfer of flavors between cooked foods.

Known pressure fryers use a cooking vessel or cooking well that, again, is sealed and pressurized. One known pressure fryer, disclosed in Richard et al., U.S. Pat. No. 7,134,385, which patent is commonly assigned with the present application, has a circular, downwardly an inwardly tapered cooking well that operates between 12-14 psi gauge pressure at temperatures up to 375° F. The cooking well is formed from 300 series stainless steel.

Heat can be provided by gas fired burners or electric elements. Gas fired burners are conventional blue-flame burners. Heat transfer from the source, i.e., the flame, is essentially by convection only as the temperatures are not sufficiently high to produce heat transfer by other transfer means. A series of straight fins extend longitudinally, upwardly along the outer well wall to facilitate heat transfer to the well. It will be appreciated that while such an arrangement provides significant heat transfer to the well, and thus the cooking oil, a significant amount of energy is lost to the environment as a result of heating the pressurized cooking well by use of a blue flame.

It will also be appreciated the oil must be filtered at various times depending upon the frequency of use. During a down-time, usually a number of times during the work day, the oil is conveyed to a filter in the fryer, to filter out cooked food debris. In an known pressure fryer, the filter is a tray having openings that is located at the bottom of the fryer. A filter media is positioned in the tray and the oil is deposited in the tray. Once filtered, the oil is then pumped back into the cooking well. In a fairly typical day, filtering is carried out about every five cooking cycles and the media is changed out about every three filtering cycles. Again, in a typical commercial setting this is less than one day of cooking.

The time to filter the oil is about five minutes and the time to change out the filter media is about 15-20 minutes. Filter media change-out requires labor to clean out the filter pan and to dispose of the filter media. In addition, diatomaceous earth is used to achieve the desired level of filtration. As such, in addition to disposal of the used oil, the diatomaceous earth also requires disposal.

Accordingly, there is a need for a pressure fryer having an increased fuel usage efficiency. Desirably, such increased efficiency is made without increasing the physical size of the pressure fryer and without changing the fuel type used for the fryer. More desirably, such a pressure fryer has an improved filtering system that reduces the time and labor required for filtering the cooking oil.

### SUMMARY

In one aspect, an improved pressure fryer includes a cooking vessel having a cooking well with a conical bottom and a substantially vertical sidewall extending upwardly from the conical bottom. A cover covers the cooking well.

A series of vertical fins are mounted to the sidewall. The vertical fins are spaced from one another. In an embodiment, a series of undulating fins are mounted between the vertical fins. In an embodiment, the undulating fins define peaks and troughs. The series of undulating fins can include first and second fin elements. The cooking vessel can include a coating on a portion thereof. In an embodiment, the coating is disposed on a lower portion of the cooking vessel, below the fins. The coating can be, for example, a material to enhance heat transfer from a heat source to the cooking vessel.

The first and second fin elements are mounted to each other in an opposing overlying configuration, such that the peaks of the first fin elements overlie the toughs of the second fin element. The undulating fins can extend along a portion of the sidewall. The cooking vessel can include a heat shield positioned over the vertical and undulating fins.

The heat source for the cooking vessel can include a burner, such as an infrared (IR) burner.

In another aspect, a filter system for a pressure fryer includes a filter vessel having a body, an inlet, and an outlet. The filter system can include a vent line and a vent valve in the vent line. An outer basket is disposed in the body and has a sidewall having openings therein. The outer basket has a bottom wall. An inner basket is disposed in the outer basket. A sidewall of the inner basket has openings therein. The inner basket has a bottom wall.

A filter media can be disposed between the inner basket and the outer basket. In an embodiment, the filter media is reusable. In some embodiments, the outer and basket bottom walls are devoid of openings.

In an aspect, the filter system includes a pump fluidically communicating with the filter vessel. The pump can be in communication with the outlet to draw and discharge a liquid from filter vessel.

A method for filtering used cooking oil in a pressure fryer, which pressure fryer has a filter system having a filter vessel having a body, an inlet, an outlet, inner and outer baskets disposed in the body, a sidewall of the baskets having openings therein, a filter media disposed between the inner and outer baskets, and a pump fluidically communicating with the filter vessel, includes drawing a vacuum in the filter vessel, conveying the used cooking oil into the filter vessel, through the inner basket, the filter media and the outer basket to produce filtered used cooking oil.

Some methods include opening a vent valve in a vent line as the used oil is conveyed into the filter vessel, pumping filtered used cooking oil from the filter vessel, closing the vent valve as the filtered used cooking oil is pumped from the filter vessel, isolating the pump and drawing a vacuum in the filter vessel.

In an aspect, a pressure fryer includes a cooking well having a conical bottom and a substantially vertical sidewall extending upwardly from the conical bottom. A series of vertical fins is mounted to the sidewall. The vertical fins are spaced from one another. A series of undulating fins is mounted between the vertical fins.

A heat shield surrounds the cooking well and the vertical and undulating fins. The heat shield has an upper wall extending to the cooking well. An outer cover covers the heat shield and defines an exhaust gas chamber between the outer cover and the heat shield.

In an embodiment, a series of openings are formed in the heat shield upper wall. The openings can be formed as elongated slots in the upper wall.

The pressure can include an exhaust gas port and an exhaust stack. The exhaust gas port is in communication with the exhaust gas chamber. In an embodiment, the pressure fryer includes two exhaust gas ports.

In an embodiment, the pressure fryer includes an infrared (IR) burner. The cooking vessel can include a coating on a portion thereof, such as on the conical portion of the vessel. The coating can extend to about the series of vertical fins and undulating fins.

In another aspect, a pressure fryer includes a cooking vessel having a cooking well having a conical bottom and a substantially vertical sidewall extending upwardly from the conical bottom. A multi-shelf rack system includes a plurality of risers, each riser including engagement members positioned at a distance along the risers corresponding to engagement members of the others of the risers to define a shelf plane. A lift is operably connected to the multi-shelf rack system such that the lift is configured to raise and lower the cover and the multi-shelf rack system to raise and lower the risers together with one each other.

A drive can be operably connected to the lift to raise and lower the cover and the multi-shelf rack system.

The engagement members can include elongated notches formed in the risers, which notches include a bottom lip. In embodiments, one of the engagement members in a shelf plane includes a finger depending from an upper edge thereof, spaced from a back wall of the elongated notch. The fryer includes one or more fryer shelves that are secured in the risers at the notches. In an embodiment of the fryer shelves, a rim of each shelf is positionable in the elongated notch and the finger is engageable with the rim to secure the shelf in place in the riser.

These and other features and advantages of the present device will be apparent from the following description, taken in conjunction with the accompanying sheets of drawings, and in conjunction with the appended claims.

### BRIEF DESCRIPTION OF THE DRAWINGS

The benefits and advantages of the present embodiments will become more readily apparent to those of ordinary skill in the relevant art after reviewing the following detailed description and accompanying drawings, wherein:

FIG. 1 is a perspective rendering of an embodiment of a pressure fryer having improved heating and filtering systems, the fryer being illustrated with a side panel removed and a front door open for ease of viewing;

FIG. 2 is a side view of the pressure fryer;

FIG. 3 is another side view of the fryer, reversed from FIG. 2, and shown in partial sectional view, illustrating the cooking vessel and filter;

FIG. 4 is another partial sectional view of the pressure fryer shown in a top perspective view;

FIG. 5 is a side view of the cooking well showing the vertical and undulating fins;

FIG. 6 is an enlarged view of a portion of the side of the cooking well showing the vertical and turbulator fins;

FIG. 7 is a side view of a turbulator fin;

FIG. 8 is a perspective view of an embodiment of an infrared burner;

FIG. 9 is a partial sectional view of an embodiment of a filter system used in the pressure fryer;

FIG. 10 is an exploded view of the filter system of FIG. 9;

FIG. 11 is a side view of the filter vessel showing the inlet and outlet lines;

FIG. 12 is an enlarged partial view showing the filter vessel latch;

FIG. 13 is a perspective view of a pressure fryer with a side panel removed for ease of illustration, the illustrated pressure fryer shown with a tray filter;

FIG. 14 is a partial view of the tray filter system;

FIG. 15 is a side view of the pressure fryer illustrating the filter system components;

FIG. 16 is perspective rear view of illustrating the filter system components;

FIG. 17 is a partial sectional view of the cooking well illustrating portions of the heating system;

FIG. 18 is a perspective view of the cooking well with a portion of the outer cover removed for ease of illustration;

FIG. 19 is a side view of a pressure fryer showing a dome and shelf lift system, the fryer illustrated with a side panel removed;

FIG. 20 is a perspective view of the lift system of the fryer of FIG. 19 illustrated with the cover and dome in the open state;

FIG. 21 illustrated a shelf system, frame and dome;

FIG. 22 is an exploded view of another shelf and lift system; and

FIG. 23 illustrates two of the shelves positioned on a tray for a holding rack.

### DETAILED DESCRIPTION

While the present disclosure is susceptible of embodiment in various forms, there is shown in the drawings and will hereinafter be described one or more embodiments with the understanding that the present disclosure is to be considered illustrative only and is not intended to limit the disclosure to any specific embodiment described or illustrated.

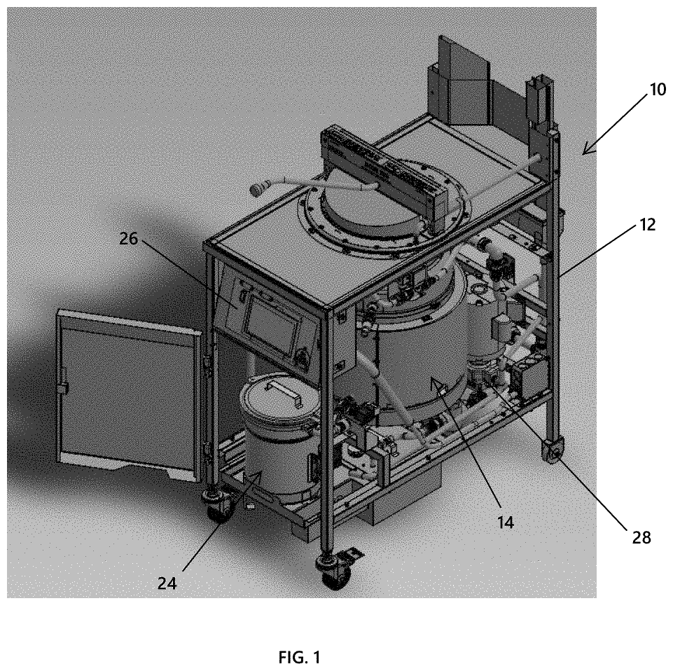

Referring now to the figures and in particular to FIGS. 1-4, there is shown an embodiment of a pressure fryer 10. The pressure fryer 10 (referred to herein as “fryer”) includes a frame 12, a cooking vessel system 14 including a cooking well 16, a cover 18, a burner system 20 and heat shield 22, a filter system 24 and a controller 26. The controller 26 controls the overall operation of the fryer 10. The fryer 10 further includes a pump 28, valves and piping, as will be discussed in more detail below, to transport oil through the system. In an embodiment, the pump 28 is located downstream of the filter system 24 to draw oil from the filter system 24. It will, however, be understood that the pump 28 can be located upstream of the filter system 24 so as to pump oil into the filter system 24.

The cooking well 16 is configured to store a quantity of heated oil, under pressure, to cook the food items in the well 16 while under pressure. In a typical arrangement, the oil may be heated to, and the food cooked at, a temperature of about 375 deg.F. at a pressure of about 12-14 psig. These cooking conditions have been shown to cook food faster, with less oil absorption, and thus less oil consumption, than deep frying.

The cooking well 16 has a conical bottom 30 and a substantially straight cylindrical sidewall 32 extending upwardly from the conical bottom 30. An upper end of the sidewall 32 may include a flange 34 or like mounting member for mounting the cooking well 16 to the frame 12. The sidewall 32 may include a tapered collar 36 as it extends upwardly toward the flange 34. Inlets and outlets (for the transport of oil) can be formed in the sidewall 32 for conveying oil into and out of the cooking well 16. The cooking well 16 may also include one or more vents and the like, as will be recognized by those skilled in the art.

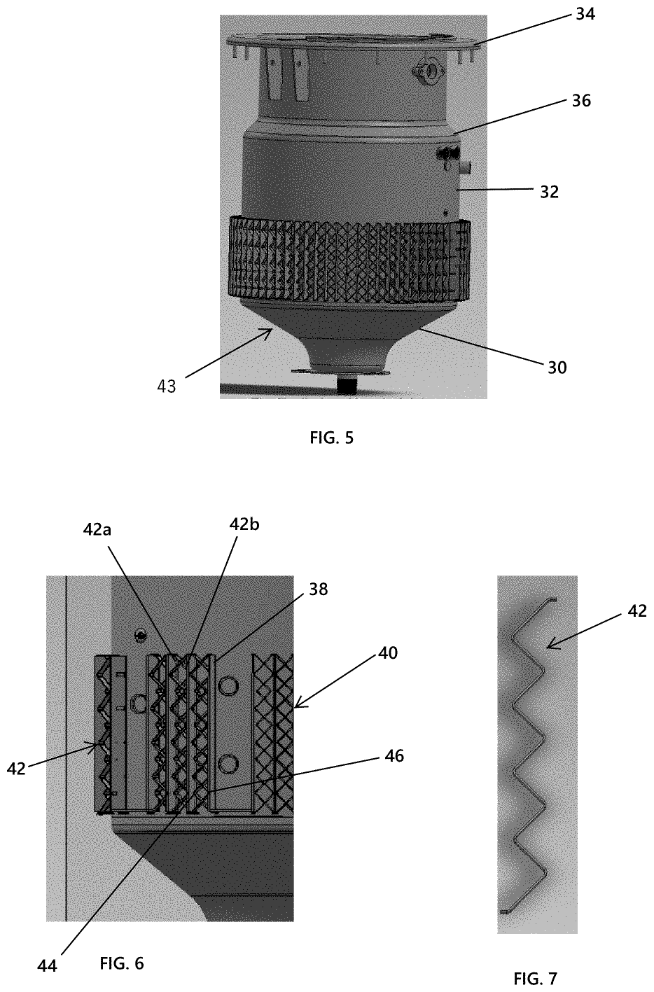

In order to increase the heat transfer from the burner 20 (which will be described in more detail below), the cooking well 16 includes a series of vertically extending fins 38 mounted to an outside surface of the well 16. In an embodiment, the fins 38 are mounted to the straight sidewall 32, above the conical bottom 30. The fins 38 may be mounted to a portion of sidewall 32, for example, a lower portion 40 of the sidewall 32. The fins 38 increase the surface area over which heat is transferred from the burner 20 to the well 16. In addition to the vertical fins 38, the present fryer 10 includes a series of turbulator fins 42 as best seen in FIGS. 5-7. The turbulator fins 42 are undulating elements that, in an embodiment are positioned between adjacent vertical fins 38.

In an embodiment, the undulating shape of the turbulator fins 42 is a zig-zag shape (e.g., a group of “Z”s joint to one another defining peaks 44 and troughs 46) as seen in FIG. 7. Other undulating shapes, such as sinusoidal shapes and the like will be recognized by those skilled in the art. As seen in FIG. 6, in an embodiment, the turbulator fins 42 are positioned in opposing pairs between vertical fins 38. That is, the turbulator fins 42 are stacked on each other in opposite directions such that the peaks 44 of a fin, for example fin 42a oppose the troughs 46 of its fin pair, for example, fin 42b.

It has been observed that the turbulator fins 42, in conjunction with the vertical fins 38, increase the heat transfer from the burner 20 to the cooking well 16. The turbulator fins 42 increase the surface area in contact with the heated air (and/or burner 20 combustion products) and the surface area in contact with the cooking well 16 outer wall. In addition, the tortuous path (the zig-zag path) that the heated air takes along the turbulator fins 42 increases the contact time of the heated air with the fins 38, 42, generally, and creates a more turbulent flow of heated air along the heat transfer surfaces (the fins 38, 42 and cooking well 16 wall). As such, more energy is transferred from the heated air to the cooking well 16, thus increasing the efficiency of the burner system 20.

In an embodiment, a lower portion 43 of the cooking well 16, for example, the conical bottom 30, up to the fins 38, 42 may be coated with a material to enhance heat transfer from to the cooking well 16. For example, the coating may be a black coating such as a black oxidize coating, a black paint, such as a high temperature silicone-based flat black paint. A preferred material has a high absorptivity and a low emissivity.

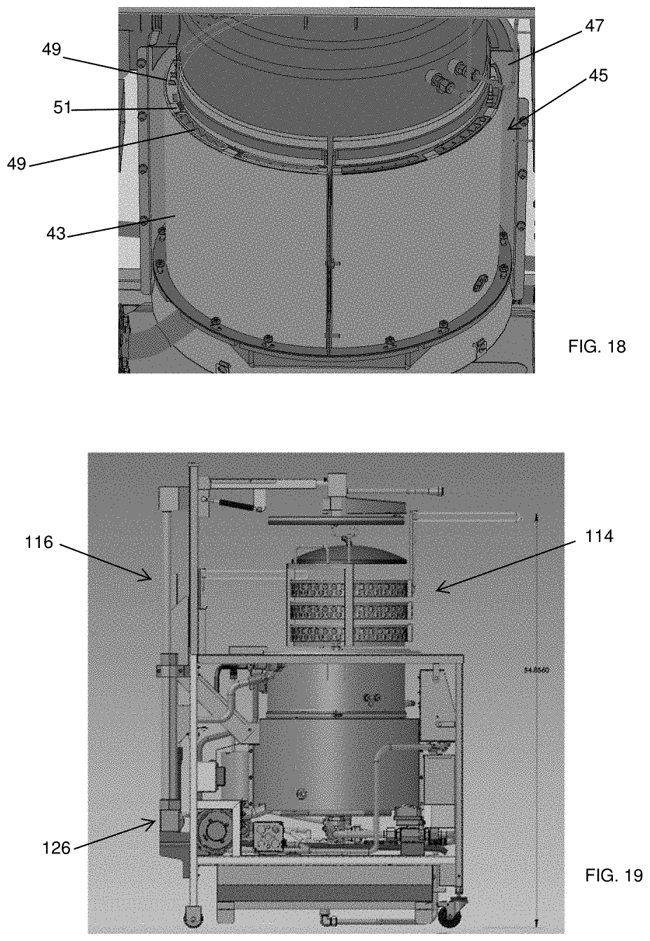

Referring to FIGS. 17 and 18, in order to maintain the heated air around the cooking well 16 and the vertical and turbulator fins 38, 42, the heat shield 22 is positioned around that portion 40 of the cooking well 16 along which the fins 38, 42 extend. This also increases the heat transfer from the heated air to the cooking well 16.

An outer cover 43 extends around the heat shield 22 and defines an exhaust gas chamber 45 between the outer cover 43 and the heat shield 22. The exhaust gases from combustion exit the heat shield 22 (after heat transfer to the cooking well 16 via the fins 38, 42) through the exhaust chamber 45, and exit the fryer 10 through the exhaust stack 50. In an embodiment, the fryer 10 can include two exhaust ports 47 (one shown) that combine for the exhaust gases to exit through the common stack 50.

As best seen in FIGS. 17 and 18, the heat shield 22 can include a series of slots 49, such as the elongated slots, in an upper wall 51 that provide communication for the exhaust gases from around the fins 38, 42 to the exhaust gas chamber 45. The slots 49 facilitate a uniform distribution of the combustion gases around the cooking well 16, which helps to maintain even heating of the well 16 and prevents hot spots around and in the cooking well 16.

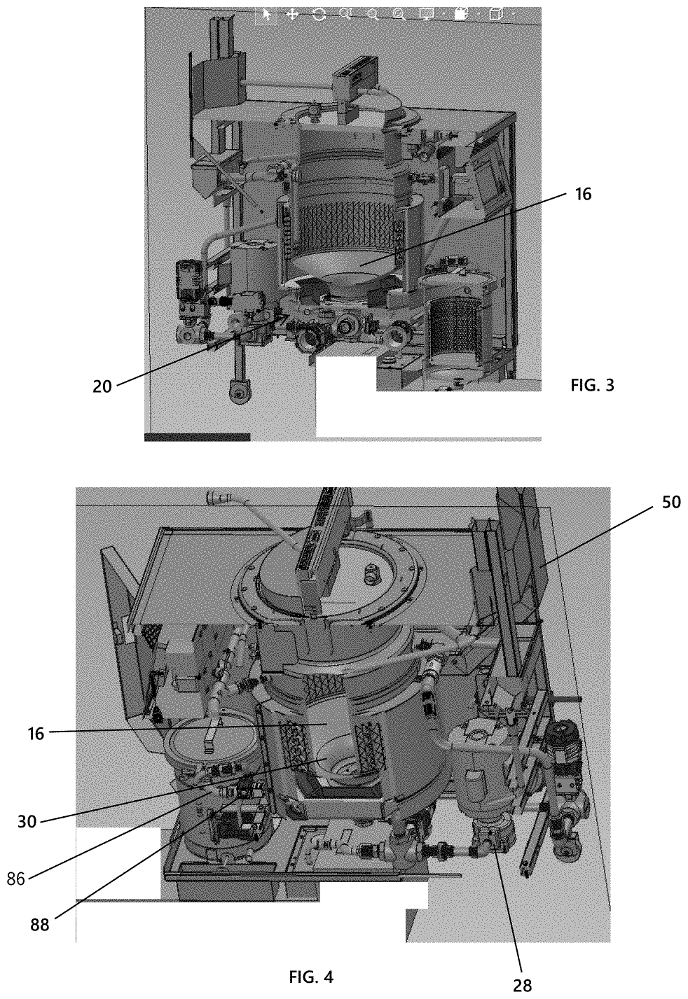

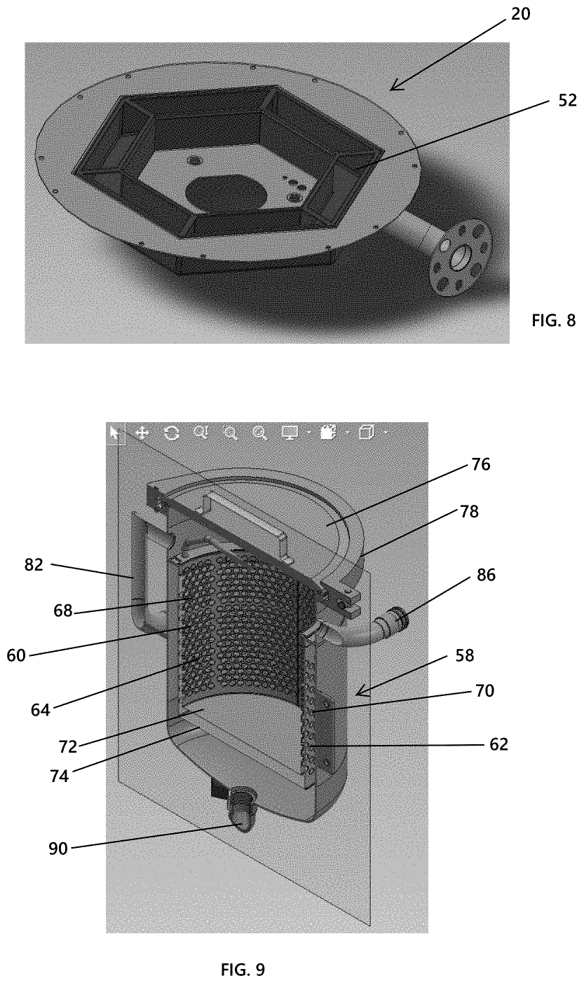

Referring to FIGS. 3, 4 and 8, an embodiment of the fryer 10 uses an infrared (IR) or radiant burner system 20. Unlike known fryers that use blue flame burners that heat using convective heat transfer, the IR burner system 20 heats the cooking well 16 through a combination of radiation (or radiant) and convective heat transfer. The use of radiant heat transfer provides a number of advantages. For example, IR heating elements 52 will heat objects by radiation (as well as surrounding air by convention), and as such will more efficiently heat the cooking well 16 and fins 38, 42. This is because the heated fins 38, 42 will then transfer heat by conduction to the cooking well 16, which is a more efficient heat transfer mechanism than convective heat transfer. Moreover, IR heating elements 52 tend to reach higher temperatures than blue flame temperatures, again, increasing efficiency of the overall burner system 20. In fact, it has been found that in pressure fryers, while traditional blue flame burner systems operate at an efficiency of about 35-40 percent, the present IR burner system 20 operates at an efficiency of about 70 percent, thus providing a significant increase in efficiency and reduction in fuel costs.

The IR heating elements 52 can be metal, such as tungsten, iron, chromium, aluminum, alloys and combinations of these, and non-metals, such as ceramic, carob and the like and in combination with one or more metals. Such IR heating elements will be recognized by those skilled in the art.

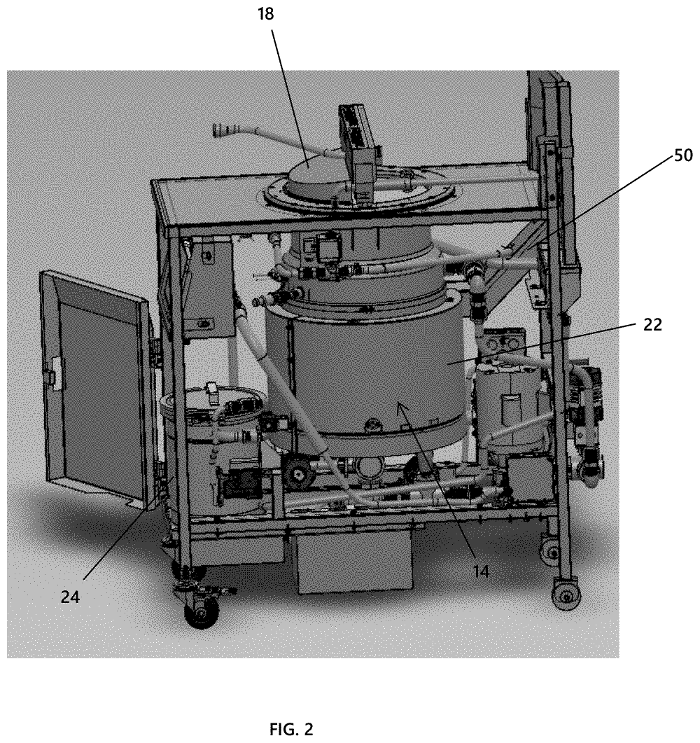

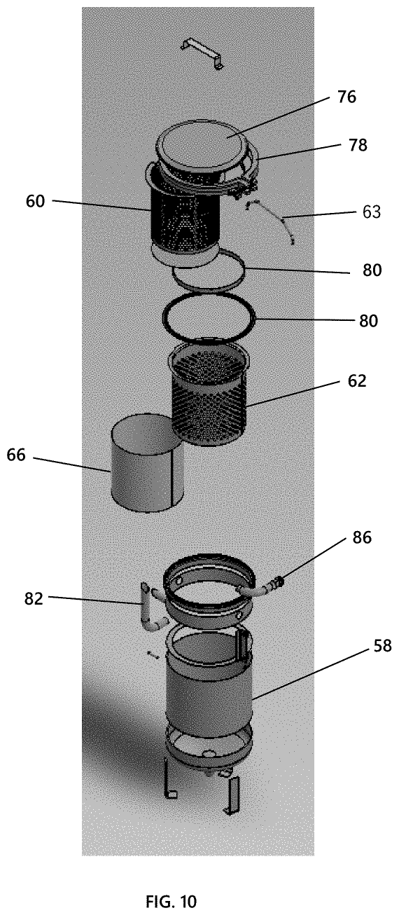

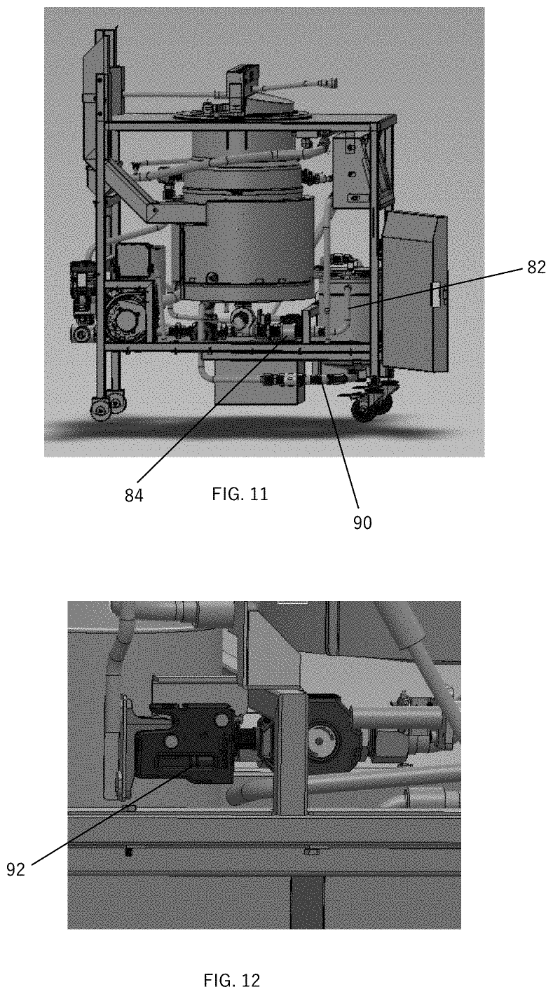

Referring now to FIGS. 2, 4 and 9-10, there is shown an embodiment of one filter system 24 for the fryer 10. The illustrated filter system 24 uses a filter vessel 58 in which the oil is filtered to remove cooking debris. The system 24 includes the vessel 58 and inner and outer baskets, 60, 62, respectively. positioned in the vessel 58. The baskets 60, 62 have a series of openings or perforations 64 and a filter media 66 is positioned between the inner and outer baskets 60, 62. In an embodiment, the baskets' 60, 62 openings are formed in the baskets' walls 68, 70 (wall is singular since the baskets are round or cylindrical in shape), and solid, non-open bottoms 72, 74. In such a configuration, the filter media 66 can be, for example, a sheet material that encircles the inner basket wall 68. A present filter media 66 is a polymeric material. In an embodiment, the filter media 66 can be cleaned by scraping and is reusable. Other suitable media 66 materials, for example, Teflon-based media, will be recognized by those skilled in the art, and some media 66 may be cleaned, in for example, a dishwasher.

The filter system 24 includes a cover 76 and a clamp 78 to retain the cover 76 on the vessel 58, and one or more seals 80 between the vessel 58 and the cover 76. One or both of the baskets 60, 62 can have handles 63 for lifting and removing the baskets 60, 62 from the vessel 58.

In an embodiment, one or both of the inner and outer baskets 60, 62 may include openings in the bottom walls 72, 74. The baskets 60, 62 can be made of a metal, such as stainless steel; however, those skilled in the art will recognize and appreciate that other suitable materials, such as materials using metallized foam technology and non-metals may be used for one or both of the inner and outer baskets. In some embodiments, the basket material may allow for use of a single basket and/or use of a single basket or multiple baskets without a filter media.

The filter system 24 includes an inlet and line 82, and an inlet valve 84. The system 24 may also include a vent line 86 and a vent valve 88 positioned in the vent line 86. In an embodiment, the vent valve 88 is a solenoid operated valve; however, other suitable valve types will be recognized by those skilled in the art. An outlet line 90 draws oil from the bottom of the vessel 58. In an embodiment, the pump 28 draws oil from the filter vessel 58 outlet line 90, and returns the oil to the cooking well 16.

In one contemplated use, oil is transferred from the cooking well 16 to the filter vessel 58 by gravity. As the vessel 58 fills, the oil is drawn through the inner basket 60, through the filter media 66 and outer basket 62 and out through the vessel outlet 90. The oil can be drawn from the filter vessel 58 by the pump 28 and returned to the cooking well 16.

In one method of oil filtration, before oil is transferred to the filter, the filter vessel 58 has a slight negative pressure as will be described in more detail below. In, such a method, as oil is pumped out of the filter vessel 58, the vent valve 88 is opened to reduce any vacuum developed in the vessel 58, which facilitates pumping out the vessel 58. As the vessel 58 empties at the end of the filtering cycle, the vent valve 88 is closed to create a slight vacuum (slight negative pressure) in the vessel 58, just prior to isolating the pump 28 to end the filtering cycle. In this way, when the next filtering cycle begins, and the oil is returned to the filter vessel 28, the negative pressure in the vessel 58 increases the flow rate of oil from the cooking well 16 to the filter vessel 58.

The vent valve 88 also serves as a safety feature during cooking. In the event the isolation valve (is this the filter inlet valve) leaks, the normally closed vent valve 88 can be actuated during cooking to ensure that pressure will not build up in the filter vessel 58. In addition, there is a mechanical latch 92 that keeps the filter vessel 58 locked in place to allow assembly and removal of the filter baskets 60, 62 and media 66 without tools. The latch 92 also enhances safety if the vessel 58 is accidentally pressurized by a leaking (inlet) isolation valve by securely maintaining the filter vessel 58 in place on the frame 12.

Food cooking debris, such as crumbs, are removed by opening the cover 76 on the filter vessel 58 and simply lifting and separating the inner basket 60 from the outer basket 62. This can be carried out about every 25 cycles, or the following day when the filter 24 has cooled down. It is estimated that the time to carry out the filtering process (e.g., transferring oil from the cooking well 16 through the filter vessel 58, inner and outer baskets 60, 62 and filter media 66, and pumping the oil back to the cooking well 16) is about 1½ minutes (90 seconds) and crumb removal and return to operation will be less than 5 minutes. Advantageously, the present filtering system 24 does not require filtering compounds (no diatomaceous earth) and achieves a finer micron filtering level than known filter systems, at about 0.5 microns.

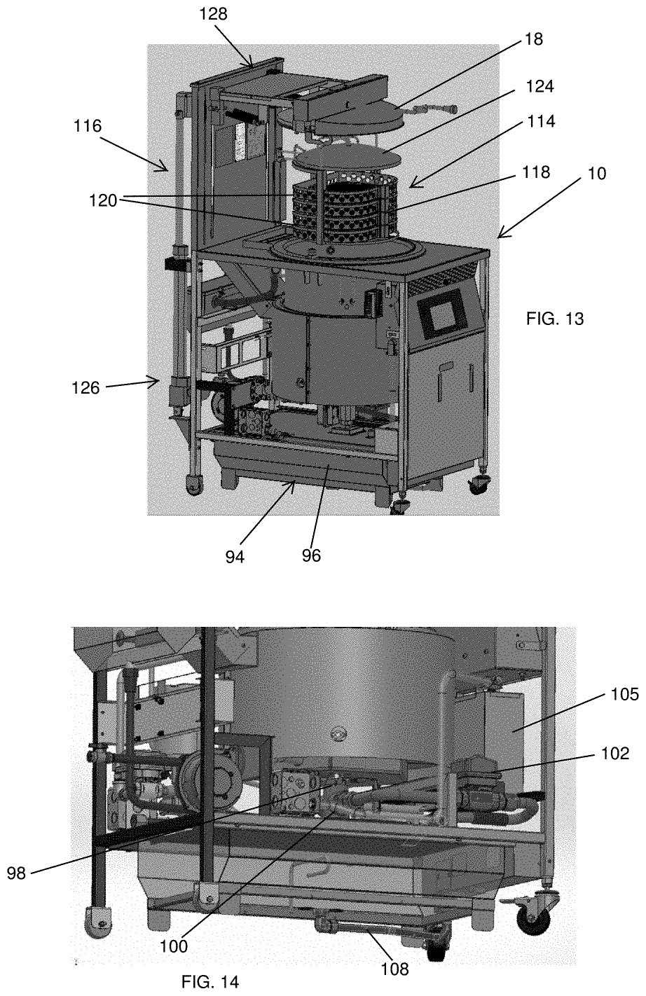

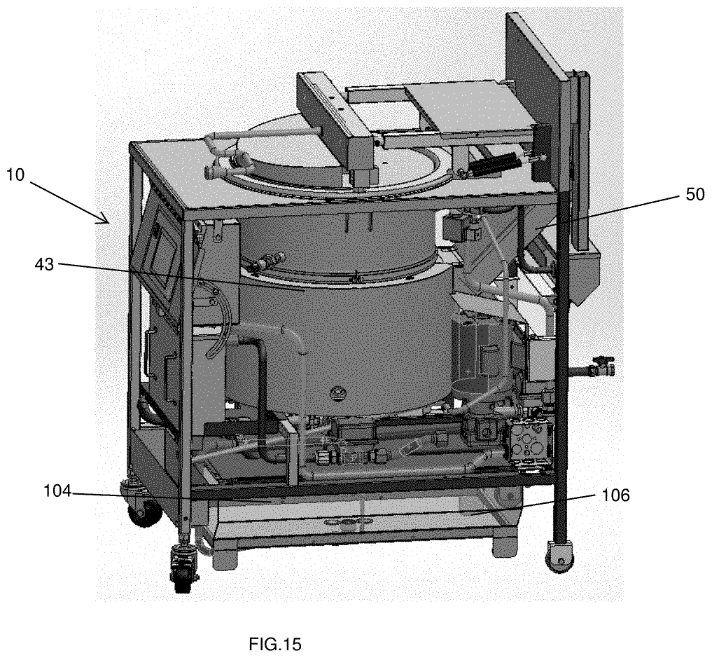

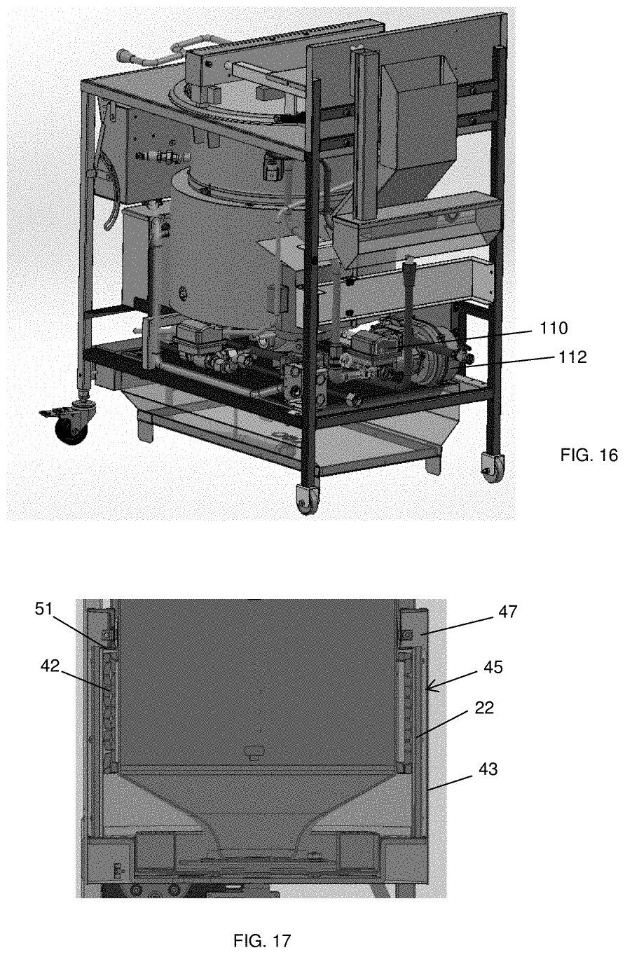

Referring to FIGS. 13-16, in an alternative embodiment, the fryer 10 can use an oil filter system 94 in which an oil filter tray 96 is positioned at about the bottom of the fryer 10. A drain line 98 from the cooking well 16 opens to a three-way drain valve 100 located below the vessel 14. An isolation valve 102 is positioned downstream of the three-way valve 100 and allows the oil to flow to the top of the filter cover 104, from which the oil flows into the filter 106. An oil reservoir 105 is positioned on the front of the fryer 10.

Oil is discharged from the filter tray 92 through a riser line 108 at about the bottom of the tray 92. The oil is then drawn through a replenish valve 110, into an oil pump 112, and to the cooking well 16. The use of a three-way drain valve 100 allows for.

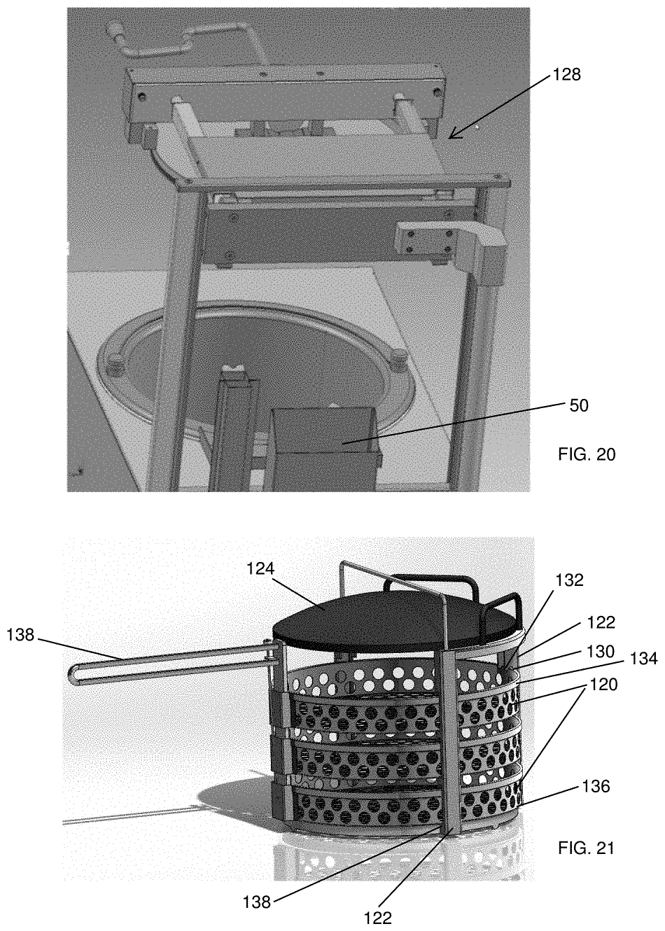

Referring now to FIGS. 13 and 19-23, the fryer 10 can include a multi-shelf rack system 114 and auto-lift system 116. In a current embodiment, the multi-shelf rack system 114 includes a tiered rack 118 and shelves 120. The rack system 118 includes a series of upstanding risers 122 to support the shelves 120. The risers 122 are mounted to a domed lid 124 that is mounted to the fryer cover 18 and is operably connected to a lift system 116. In an embodiment the risers 122 depend from the domed lid 124.

The lift system 116 can include a drive 126 and a support carriage assembly 128 operably mounted to the drive 126. The carriage 128 can be a horizontally extending assembly that extends over the cooking well 16 to support the domed lid 124, racks 122 and shelves 120 over the cooking well 16. The cover 18, domed lid 124 and risers 122 are mounted to the carriage 128 such that they are raised upward from the cooking well 16 by actuation of the drive 126. Once the cover 18, domed lid 124 and risers 122 are raised above the cooking well 16, the cover 18 can be slid away from the risers 122, shelves 120, and domed lid 124 to remove the shelves 120. For cooking, the risers 122, shelves 120, and domed lid 124 are lowered by the lift 116 such that the risers 122 and shelves 120 are lowered in the cooking well 16 and the domed lid 124 closes the well 16.

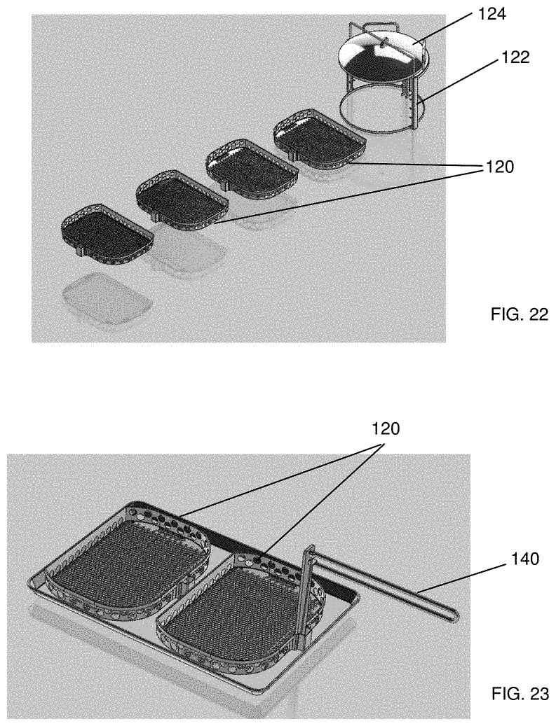

As seen in FIGS. 21 and 22 the risers 122 include notches 130 with depending fingers 132 that are configured to engage the shelves 120. For purposes of clarity, reference will be made to a single shelf 120, but it is to be understood that the following description applies to each of the shelves 120. An upper edge 134 of the shelf 120 is inserted into the notches 130 behind and bearing against the finger 132 of a rear notch 130. A lower edge 136 of the shelf 120 engages lips 138 in the bottom of the notches 130 to secure the shelf 120 in the risers 122. The bask shelf et 120 is maintained in place by the engagement of the shelf upper edge 132 and the notch depending finger 132 and by engagement of the shelf lower edge 136 with or resting on the lips 138 on the bottom of the notches 130. To remove the shelf 120, the shelf 120 is lifted by its handle 140, raising it off of the notches 130 and the shelf 120 is angled out of the notch depending finger 132. Each of the shelves 120 is independently positionable in and removable from the risers 122.

It will be appreciated that the various alternative embodiments and systems/subsystems can be used with others of the various alternative embodiments and systems/subsystems without limitation.

In the present disclosure, the words “a” or “an” are to be taken to include both the singular and the plural. Conversely, any reference to plural items shall, where appropriate, include the singular. It will also be appreciated by those skilled in the art that the relative directional terms such as upper, lower, rearward, forward and the like are for explanatory purposes only and are not intended to limit the scope of the disclosure.

All patents or patent applications referred to herein, are hereby incorporated herein by reference, whether or not specifically done so within the text of this disclosure.

From the foregoing it will be observed that numerous modification and variations can be effectuated without departing from the true spirit and scope of the novel concepts of the present film. It is to be understood that no limitation with respect to the specific embodiments illustrated is intended or should be inferred. The disclosure is intended to cover by the appended claims all such modifications as fall within the scope of the claims.

1. A pressure fryer, comprising:
a cooking vessel having a cooking well having a conical bottom and a substantially vertical sidewall extending upwardly from the conical bottom;
a cover for covering the cooking well;
a multi-shelf rack system including a plurality of risers, the risers each including engagement members positioned at a distance along the risers corresponding to engagement members of the others of the risers to define a shelf plane; and
a lift operably connected to the multi-shelf rack system,
wherein the lift is configured to raise and lower the cover and the multi-shelf rack system to raise and lower the risers together with one each other.

2. The pressure fryer of claim 1, including a drive operably connected to the lift to raise and lower the cover and the multi-shelf rack system.

3. The pressure fryer of claim 1, wherein the engagement members include elongated notches formed in the risers, and wherein the notches include a bottom lip.

4. The pressure fryer of claim 3, wherein one of the engagement members in a shelf plane includes a finger depending from an upper edge thereof, spaced from a back wall of the elongated notch.

5. The pressure fryer of claim 1, further including a fryer shelf

6. The pressure fryer of claim 4, further including a fryer shelf, wherein a rim of the fryer shelf is positionable in the elongated notch and wherein the finger is engageable with the rim to secure the shelf in place in the riser.

7. A pressure fryer, comprising:
a cooking well having a conical bottom and a substantially vertical sidewall extending upwardly from the conical bottom;
a series of vertical fins mounted to the sidewall, the vertical fins being spaced from one another;
a series of undulating fins mounted between the vertical fins;
a heat shield surrounding the cooking well and vertical and undulating fins, the heat shield having an upper wall extending to the cooking well; and
an outer cover for covering the heat shield and defining an exhaust gas chamber between the outer cover and the heat shield.

8. The pressure fryer of claim 7, including a series of openings in the heat shield upper wall.

9. The pressure fryer of claim 7, further including an exhaust gas port and an exhaust stack, wherein the exhaust gas port is in communication with the exhaust gas chamber.

10. The pressure fryer of claims 9, including two exhaust gas ports.

11. The pressure fryer of claim 7, further including a burner, wherein the burner is an infrared (IR) burner.

12. The pressure fryer of claim 7, wherein the cooking vessel includes a coating on a portion thereof.

13. The pressure fryer of claim 12, wherein the coating is on the conical portion.

14. The pressure fryer of claim 13, wherein the coating extends to about the series of vertical fins and the series of undulating fins.
